(19) United States
(12) Patent Application Publication
(10) Pub. No.: US 2006/0126005 A1
(43) Pub. Date: Jun. 15, 2006

(54) Method for reforming color filter array of a CMOS image sensor

(76) Inventor: Dong Kwon Cha, Busan City (KR)

Correspondence Address: MCKENNA LONG & ALDRIDGE LLP, 1900 K STREET, NW, WASHINGTON, DC, 20006, US

(21) Appl. No.: 11/302,388

(22) Filed: Dec. 14, 2005

(30) Foreign Application Priority Data
Dec. 15, 2004 (KR) 10-2004-0105955

(51) Int. Cl. G02F 1/13

(52) U.S. Cl. 349/199

(57) ABSTRACT

A method is provided for reforming a color filter array of a CMOS image sensor, wherein the method includes exposing the first cap oxide layer by removing the first micro-lens, the first cap oxide layer by removing the first micro-lens, the first OCM pattern and the first color filter array; removing the exposed first cap oxide layer; forming a second cap oxide layer on an entire surface of the semiconductor substrate; forming a second color filter array on the second cap oxide layer in correspondence with the unit pixel array region; forming a second OCM pattern on the second color filter array; exposing the metal pad by selectively etching the second cap oxide layer; and forming a second micro-lens on the second OCM pattern.

### CROSS-REFERENCE TO RELATED APPLICATIONS

This application claims the benefit of Korea Patent Application No. P2004-105955 filed on Dec. 15, 2004, which is hereby incorporated by reference for all purposes as if fully set forth herein.

### BACKGROUND OF THE INVENTION

1. Field of the Invention

The present invention relates to a method for fabricating an image sensor, and more particularly, to a method for reforming a color filter array of a CMOS (Complementary Metal Oxide Silicon) image sensor to improve the reliability of the device.

2. Discussion of the Related Art

Generally, CMOS image sensor fabrication includes providing a passivation layer after forming a metal line to protect the device from moisture and scratching. A color filter array is then formed on the passivation layer after forming a pad opening. However, during the formation of the color filter array, the surface of the metal pad may be corroded or damaged. To prevent the surface of the metal pad from being damaged, a cap oxide layer is formed in the CMOS image sensor.

Hereinafter, a method for fabricating a CMOS image sensor according to the related art, which includes a cap oxide layer will be described with reference to the accompanying drawings.

FIGS. 1A to 1F are cross sectional views of the process for fabricating a CMOS image sensor according to the related art.

For a full understanding of a CMOS image sensor according to the related art, a unit pixel array region 100 and a pad contact region 150 are explained together.

As shown in FIG. 1A, a semiconductor substrate 101 is prepared. The semiconductor substrate 101 includes components for a CMOS image sensor, for example, photodiodes and MOS transistors, formed by sequential processes. An insulating layer 102 is formed on an entire surface of the semiconductor substrate 101, and a metal pad 103 for each signal line is formed on the insulating layer 102. If the metal pad 103 is formed of the same material as a gate electrode (not shown), the metal pad 103 may be formed on the same layer as the gate electrode (not shown). However, the metal pad 103 may be formed of different material from the gate electrode by an additional contact process. Generally, the metal pad 103 is formed of aluminum (Al).

A passivation layer 104 is formed on the entire surface of the semiconductor substrate 101, including the metal pad 103. The passivation layer 104 may be formed by an oxide layer or a dual-structure layer of oxide and nitride. An area of metal pad 103 is exposed by selectively etching the passivation layer 104. Subsequently, a cap oxide layer 105 is formed on the entire surface of the semiconductor substrate, including on the exposed area of the metal pad 103.

As shown in FIG. 1B, a blue-colored material is coated on the cap oxide layer 105, and an exposure and development process is selectively performed using a photo-mask, thereby forming a blue color filter B in correspondence with a photosensitive region. In the same manner, green and blue color filters G and B are sequentially formed, thereby forming a color filter array 106. Because the surface of the metal pad 103 is covered with the cap oxide layer 105, the surface of the metal pad 103 is not in contact with oxygen or hydrogen from the color filter material or developer. In this manner, it is possible to prevent the surface of the metal pad 103 from being oxidized or damaged.

To obtain good step coverage in the color filter array 106, an over-coating material (OCM) pattern 107 is formed on the unit pixel array region 100, as shown in FIG. 1C. The OCM pattern 107 is generally formed of photoresist material. The over-coating material (OCM) is deposited on the entire surface of the semiconductor substrate 101, and it is then selectively patterned by exposure and development, thereby forming the OCM pattern 107 in correspondence to the unit pixel array region 100. Subsequently, the cap oxide layer 105 is selectively etched to expose the predetermined portion of the metal pad 103, thereby forming a pad contact area 108.

As shown in FIG. 1D, a resist layer for micro-lenses is coated on the entire surface of the semiconductor substrate 101, and an exposure and development process is performed to thereby form a micro-lens pattern. Subsequently, hemispheric micro-lenses 109 are formed by reflow of the micro-lens pattern at a predetermined temperature.

If rework of defective color filter array 106 is necessary, as shown in FIG. 1E, the micro-lenses 109, the OCM pattern 107 and the color filter array 106 are removed together.

Subsequently, as shown in FIG. 1F, before performing the rework in the color filter array 106 of the photosensitive region, a cap oxide layer 110 is formed on the entire surface of the semiconductor substrate 101 such that the surface of the metal pad 103 is covered with the cap oxide layer 110. In this manner, the surface of the metal pad 103 is not in contact with oxygen or hydrogen of the color filter material or developer, and thus, it is protected from being oxidized or damaged. The OCM pattern 107, the pad open area 108 and the micro-lens 109 are sequentially formed by the aforementioned process.

The related art method for fabricating the CMOS image sensor has at least the following disadvantages.

When performing the rework in the color filter array, another cap oxide layer is formed on the first cap oxide layer and this results in the micro-lenses being further from the photodiode. Because of this distance, the light passing through the micro-lenses are out of focus, thereby causing a poor image. Additionally, performing the rework in the color filter array after removing the first cap oxide layer 105 may damage the exposed surface of the metal pad 103. Accordingly, the yield is lowered due to a pit in a bonding pad.

### SUMMARY OF THE INVENTION

The present invention is directed to a method for reforming a color filter array of a CMOS image sensor that substantially obviates one or more problems due to limitations and disadvantages of the related art.

One advantage of the present invention is that it can provide a method for reforming a color filter array of a CMOS image sensor, for example, to prevent a metal pad from being corroded, damaged and contaminated, and to improve the yield by improving reliability.

Additional examples of features and advantages of the invention will be set forth in the description which follows, or will become apparent from the description or by practice of the invention.

To achieve these and other advantages and in accordance with an embodiment of the present invention, as embodied and broadly described herein, a method for reforming a color filter array of a CMOS image sensor including a semiconductor substrate divided into a unit pixel array region and a pad region, a metal pad formed in the pad region of the semiconductor substrate, and a first cap oxide layer, a first color filter array, a first OCM pattern and a first micro-lens sequentially formed in the unit pixel array region, includes exposing the first cap oxide layer by removing the first micro-lens, the first OCM pattern and the first color filter array; removing the exposed first cap oxide layer; forming a second cap oxide layer on an entire surface of the semiconductor substrate; forming a second color filter array on the second cap oxide layer in correspondence with the unit pixel array region; forming a second OCM pattern on the second color filter array; exposing the metal pad by selectively etching the second cap oxide layer; and forming a second micro-lens on the second OCM pattern.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principle of the invention.

In the drawings:

FIGS. 1A to 1F are cross sectional views of the process for fabricating a CMOS image sensor according to the related art; and

FIGS. 2A to 2G are cross sectional views of the process for fabricating a CMOS image sensor according to the present invention.

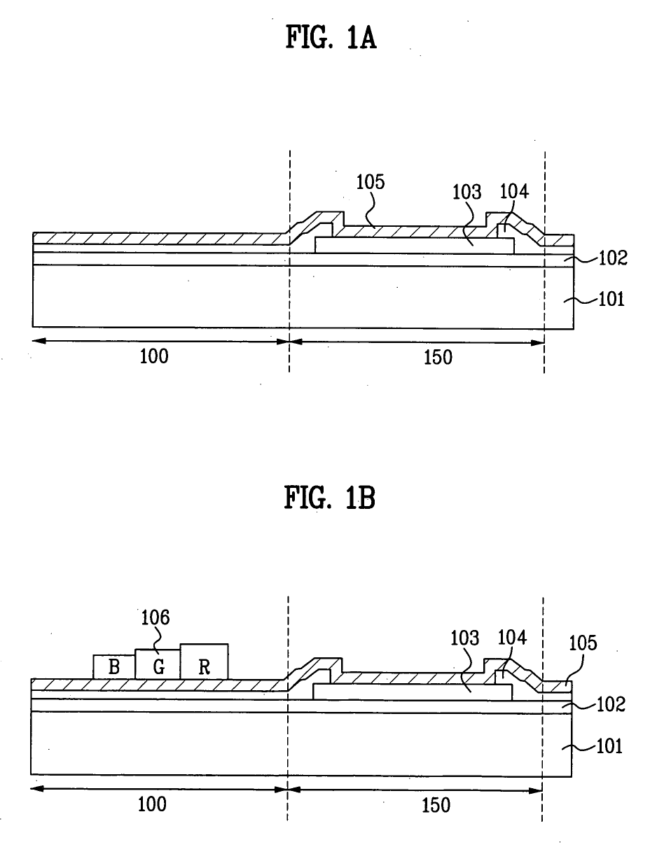

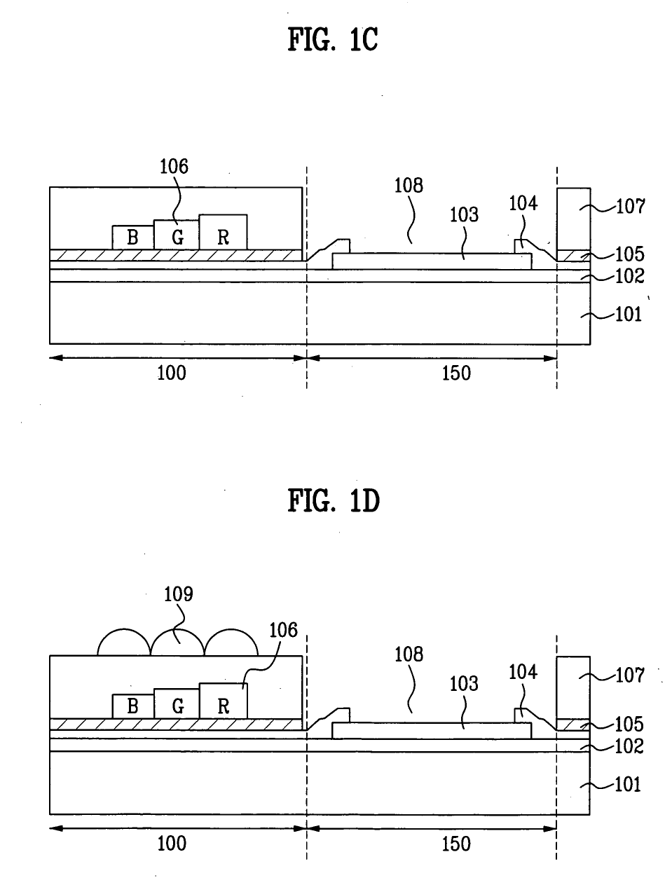

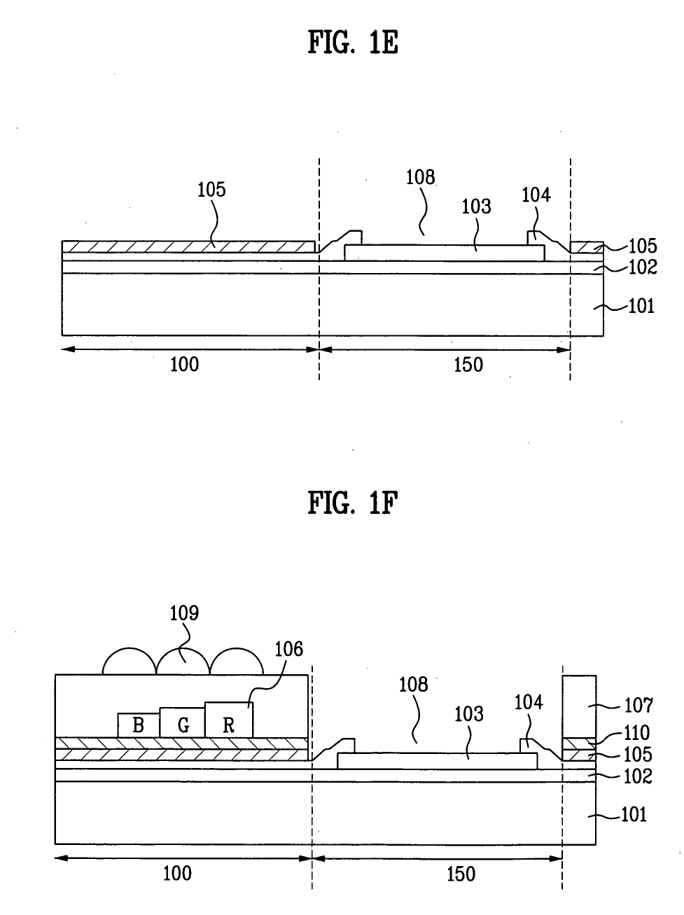

### DETAILED DESCRIPTION OF THE INVENTION

Reference will now be made in detail to embodiments of the present invention, examples of which are illustrated in the accompanying drawings. Wherever possible, the same reference numbers will be used throughout the drawings to refer to the same or like parts.

Hereinafter, a method for reforming a color filter array of a CMOS image sensor according to the present invention will be described with reference to the accompanying drawings.

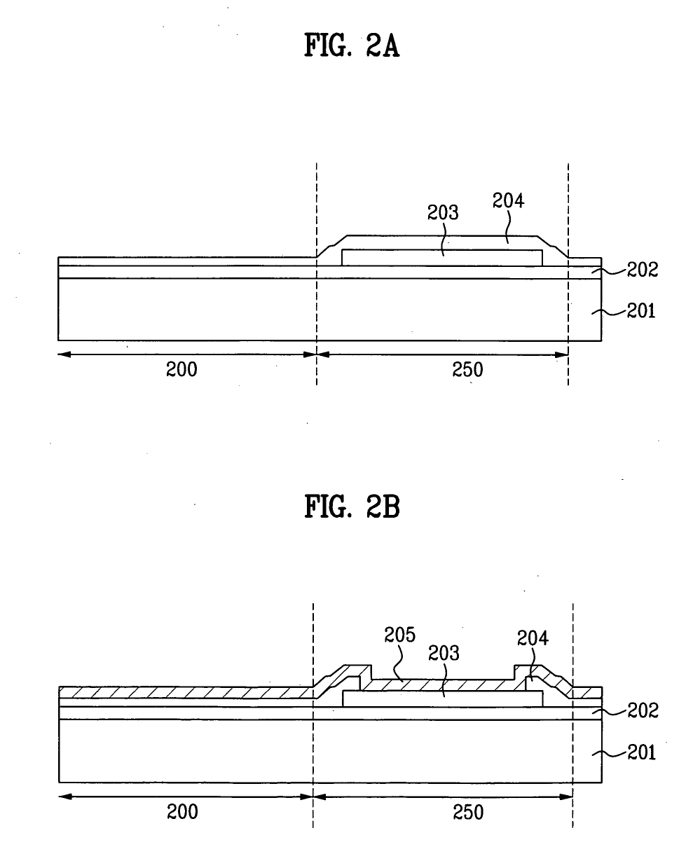

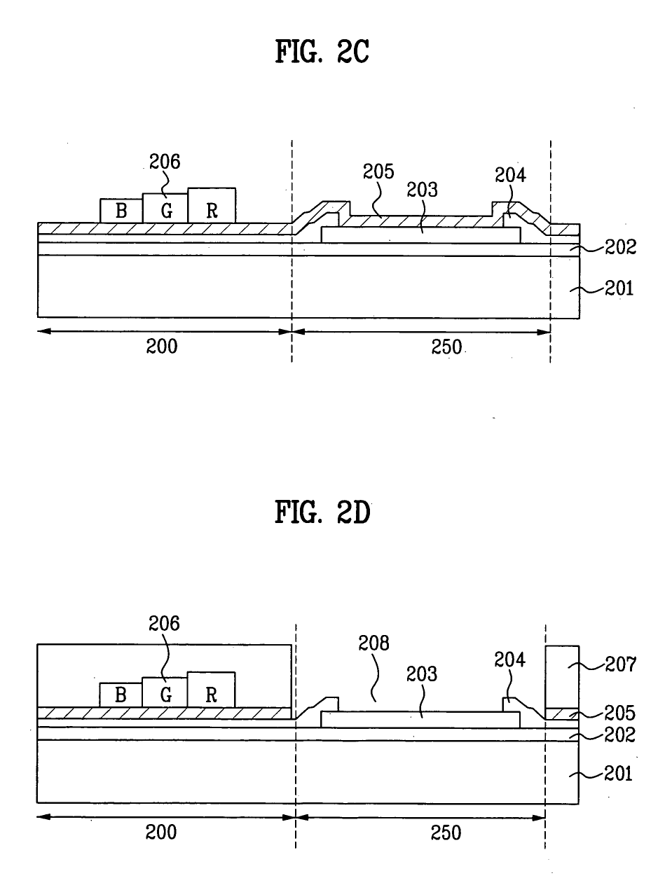

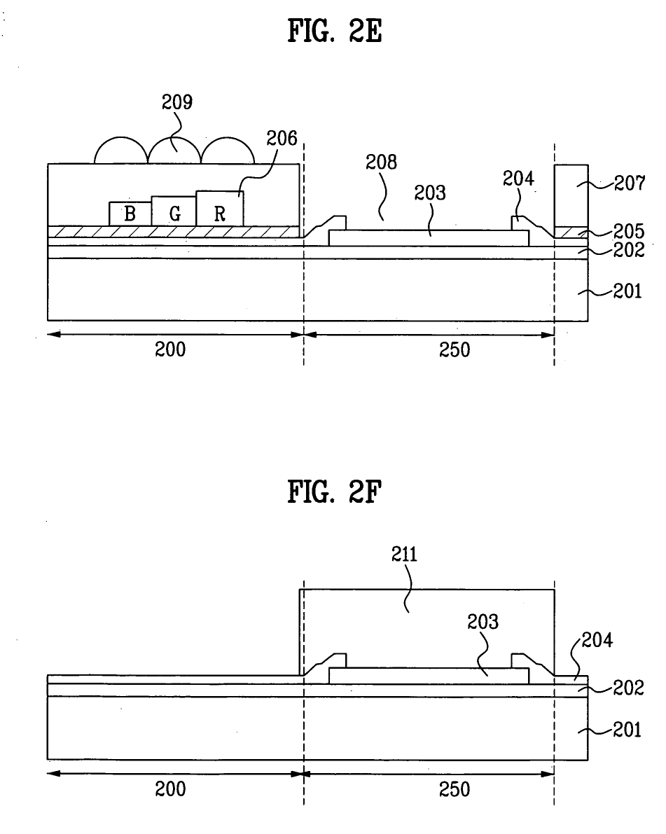

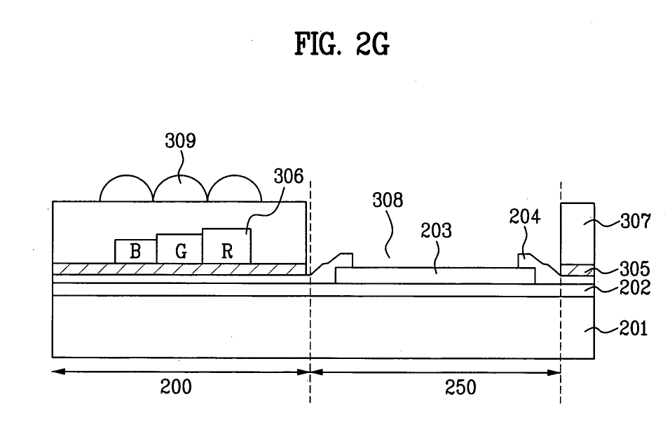

FIGS. 2A to 2G are cross sectional views of the process for fabricating a CMOS image sensor according to the present invention. In the drawings, both a unit pixel array region 200 and a pad contact region 250 are shown.

As shown in FIG. 2A, an insulating layer 202, such as a gate insulating layer or an insulating interlayer, is formed on a semiconductor substrate 201 that includes a photodiode and a MOS transistor (not shown) formed by a conventional method. Then, a metal pad 203 for each signal line is formed on the insulating layer 202.

If the metal pad 203 is formed of the same material as a gate electrode (not shown), the metal pad 203 is formed in the same layer as the gate electrode (not shown). However, the metal pad 203 may be formed of a different material from the gate electrode by an additional contact process. Generally, the metal pad 203 is formed of aluminum (Al).

A silicon nitride passivation layer 204 is formed with a thickness between 7000 Å and 9000 Å on the entire surface of the semiconductor substrate 201 including over the metal pad 203.

In the drawings, the metal pad 203 is formed as a single-layered structure. Although not shown, the metal pad 203 may be formed as a dual-layered structure. In a dual-layered structure, metal pad 203 would include a barrier metal layer and a non-reflective layer.

The passivation layer 204 may also be formed of a multiple-layered structure by combining an oxide and a nitride layers.

As shown in FIG. 2B, the passivation layer 204 is selectively etched using a mask and an etching process to expose a predetermined portion of the metal pad 203. A TEOS oxide layer 205 is then deposited at a thickness between 400 Å and 1000 Å on the entire surface of the semiconductor substrate 201 by PECVD.

As shown in FIG. 2C, a blue-colored material layer is coated on the TEOS oxide layer 205. The blue-colored material layer is then selectively patterned by an exposure and development process using a first photo-mask, thereby forming a blue color filer B over the unit pixel array region 200. In the same method, green and red color filters G and R are sequentially formed, thereby forming a color filter array 206. The color filter material used may be dyed photoresist.

During the formation of the color filter, the surface of the metal pad 203 is covered with the TEOS oxide layer 205. In this manner, the surface of the metal pad 203 is not in contact with oxygen or hydrogen from the color filter material or developer. Accordingly, it is possible to prevent the surface of the metal pad 203 from being oxidized or damaged.

As shown in FIG. 2D, for obtaining the good step coverage and improving the light transmissivity in the color filter array 206, an over-coating material (OCM) pattern 207 is formed on the unit pixel array region 200. The OCM pattern 207 is formed of photoresist material. Specifically, an over-coating material OCM is deposited on the entire surface of the semiconductor substrate 201 and it is then selectively patterned by exposure and development, thereby forming the OCM pattern 207 to correspond to the unit pixel array region 200. Subsequently, the TEOS oxide layer 205 is selectively etched to expose the predetermined portion of the metal pad 203, thereby forming a pad open area 208.

As shown in FIG. 2E, a resist layer for micro-lenses is coated on the entire surface of the semiconductor substrate 201, and an exposure and development process is performed thereto, thereby forming a micro-lens pattern. Subsequently, hemispheric micro-lenses 209 are formed by reflow of the micro-lens pattern at a temperature between about 150° C. and 200° C.

If the color filter array 206 has to be reformed, the color filters already present are removed. Then, a mask layer of photoresist 211 is formed in the pad open region 250 by using a second photo-mask, wherein the second photo-mask is opposite to the first photo-mask used when forming the OCM pattern 207. Then, the exposed TEOS oxide layer 205 is selectively removed from the unit pixel array region 200. The TEOS oxide layer 205 is selectively removed while the metal pad 203 is covered by the photoresist 211.

Subsequently, as shown in FIG. 2G, after removing the photoresist 211, a TEOS oxide layer 305 is formed on the entire surface of the semiconductor substrate 201 by PECVD. In this case, the TEOS oxide layer 305 is deposited at a thickness between 400 Å and 1000 Å. Then, a color filter array 306, an OCM pattern 307 and a micro-lens 309 are sequentially formed on the TEOS oxide layer 305 in correspondence with the unit pixel array region 200. Additionally, a pad open area 308 is formed in the pad contact region 250.

In the related art method, before another color filter array is formed, after removing the previously formed color filter array, a TEOS oxide layer is formed to prevent the metal pad from being damaged. Because a second TEOS oxide layer is deposited on the prior TEOS oxide layer, the micro-lens positioned above the TEOS oxide layer is further from the photodiode positioned below the TEOS oxide layer. This results in poor focus, and deterioration of the picture quality.

However, in case of the method for reforming the color filter array of the CMOS image sensor according to the present invention, the prior TEOS oxide layer is removed before reforming the color filter array. That is, the second TEOS oxide layer is formed after removing the prior TEOS oxide layer. Thus, the interval between the color filter array and the micro-lens is maintained appropriately, thereby it is possible to obtain the great image characteristics without additional changes in structure.

When removing the prior TEOS oxide layer before reforming the color filter array, the metal pad is covered with a photoresist. This prevents the metal pad 203 from being damaged during the removal of the TEOS oxide layer. Accordingly, it is possible to improve the reliability of device and to improve the yield in the method for fabricating the CMOS image sensor according to the present invention.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method for reforming a color filter array of a CMOS image sensor including a semiconductor substrate divided into a unit pixel array region and a pad region, a metal pad formed in the pad region of the semiconductor substrate, and a first cap oxide layer, a first color filter array, a first OCM pattern and a first micro-lens layer sequentially formed in the unit pixel array region, comprising:
exposing the first cap oxide layer by removing the first micro-lens, the first OCM pattern and the first color filter array;
removing the exposed first cap oxide layer;
forming a second cap oxide layer on an entire surface of the semiconductor substrate;
forming a second color filter array on the second cap oxide layer in correspondence with the unit pixel array region;
forming a second OCM pattern on the second color filter array;
exposing the metal pad by selectively etching the second cap oxide layer; and
forming a second micro-lens layer on the second OCM pattern.

2. The method of claim 1, wherein the second cap oxide layer is formed of a TEOS oxide layer.

3. The method of claim 1, wherein the second cap oxide layer is deposited by PECVD.

4. The method of claim 1, wherein the second cap oxide layer is formed at a thickness between about 400 Å and 1000 Å.

5. The method of claim 1, wherein the process of removing the exposed first cap oxide layer includes:
forming a mask layer on the metal pad; and
removing the exposed first cap oxide layer by using the mask layer as a mask.
